(19) United States
(12) Patent Application Publication
(10) Pub. No.: US 2007/0009071 A1
(43) Pub. Date: Jan. 11, 2007

(54) Methods and apparatus to synchronize a clock in a voice over packet network

(76) Inventor: Ranjan Singh, Morristown, NJ (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/169,605

(22) Filed: Jun. 29, 2005

(51) Int. Cl. H04L 7/00

(52) U.S. Cl. 375/354

(57) ABSTRACT

Methods and apparatus are disclosed for synchronizing a local clock in a Voice over Packet Network. In an example method, a data packet is transmitted from a transmitting device with an associated transmission frame rate determined by a remote clock signal, and is received at a receiving device. The receiving device stores the received data packet in a jitter buffer and generates a local clock signal. The data packet is retrieved from the buffer at an associated retrieval frame rate determined by the local clock signal, and an error indicative of the difference between the transmission frame rate and the retrieval frame rate is generated. The retrieval frame rate is then adjusted in accordance with the determined error.

### FIELD OF THE DISCLOSURE

This disclosure relates generally to clock synchronization in a Voice over Packet network, and more particularly, to methods and apparatus to synchronize a clock in a recovery device of a voice over packet network.

### BACKGROUND

In typical Voice over Packet (VOP) telephony applications, a transmitting device transmits voice in data packets at a pre-determined frame rate such as, for example, every 10 milliseconds (ms) over a network to a receiving device. The receiving device, in turn, processes the received packets at the same pre-determined frame rate. This nominal frame rate can have slight variations between the transmission and receiving devices, because the transmit and receive clocks may not be precisely synchronized to one another. Over time, any mismatch between the packet transmission rate and the packet processing rate may result in a transmission error that should be corrected.

For example, if the packet arrival rate is faster than the processing rate at the receiving device, the receiving device may accumulate more packets than it can process. Alternatively, if the packet arrival rate is slower than the processing rate at the receiving device, the receiving device may not have enough data to process. In either case, it is oftentimes typical that the receiving device perform a data correction step to accommodate the extra data, or lack of data, depending upon the scenario.

Some corrective approaches include, the receiving device periodically dropping excess packets or inserting duplicate packets depending upon the effective packet arrival rate. For example, the receiving device may drop a packet when there is an accumulation of packets. Similarly, the receiving device may insert a duplicate packet when there is insufficient data to correctly process the received packets.

To address some concerns regarding signal discontinuity that may effect the quality of the transmitted voice data, the receiving device may attempt to drop and/or duplicate the frames during moments of silence, so that the effect will be minimized. However, because silence is oftentimes unpredictable and occasionally sporadic, dropping or duplicating frames may still result in some discontinuity or modifications to the original waveform, thereby adversely impacting voice quality. Thus, some of the currently implemented methods utilized to adjust to differing transmission and receiving rates simply try to hide the modifications to the waveform to make them less perceptible to a listener, rather than address the underlying cause, which may be, for example, non-synchronized device clocks.

### BRIEF DESCRIPTION OF THE DRAWINGS

FIG. 1 is a schematic illustration of an example networked environment in which the example methods and apparatus disclosed herein may be employed.

FIG. 2 is a schematic illustration of an example apparatus to synchronize a clock in a Voice over Packet network.

FIG. 3 is a flowchart illustrating an example program for implementing the apparatus of FIG. 2.

FIG. 4 is s a schematic illustration of an example computer that may be used to execute the program of FIG. 3 to implement the apparatus of FIG. 2.

### DETAILED DESCRIPTION

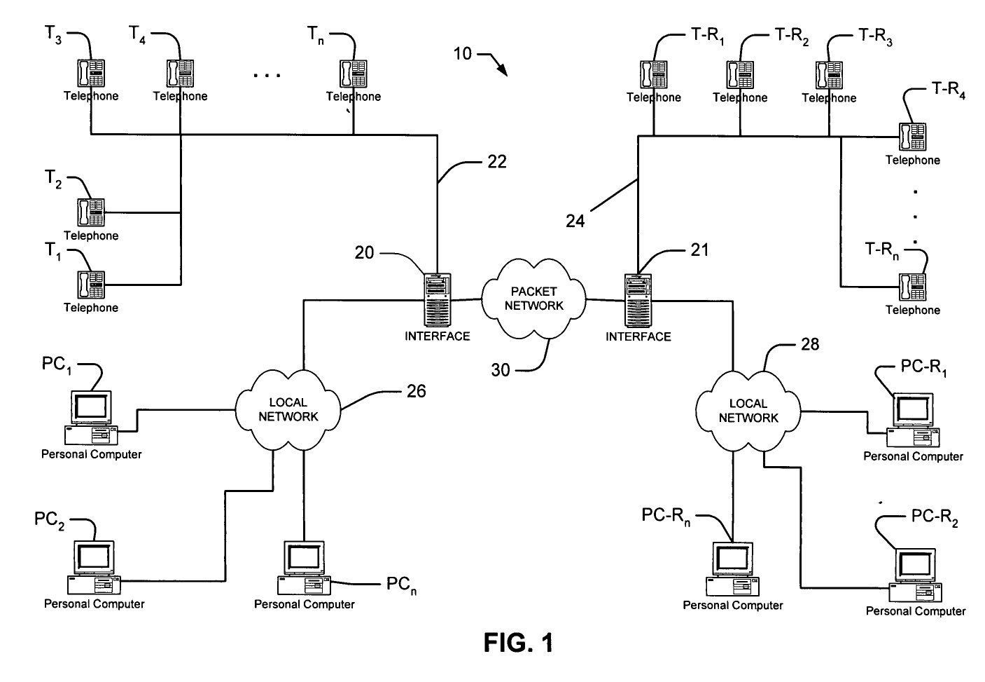

A block diagram of an example Voice over Packet (VoP) system 10 is illustrated in FIG. 1. The VoP system 10 may include a plurality of transceiver devices, such as telephones T₁ to Tₙ and T-R₁ to T-Rₙ, a plurality of personal computers PC₁ to PCₙ and PC-R₁ to PC-Rₙ adapted to transmit and receive voice communications, or any other suitable voice communication device such as, for example, wireless communication device (e.g. phone), analog telephone adaptor (ATA) devices, etc. Each of the communication devices may be electrically coupled to a respective interface 20, 21 through a direct line 22, 24, such as for example a telephony port, or via a network 26, 28, such as for example an Ethernet Network, a Local Area Network (LAN), a Wide Area Network (WAN), a Wireless Network, or any other suitable network and/or combination of networks. Each of the interfaces 20, 21 may be, for example, a gateway to provide the interface between a packet-based network (for example, an IP network) and a circuit-switched network (for example, the Public Switched Telephone Network (PSTN)), a router to provide the interface between two packet-based networks (for example, an IP network and an Intranet), or any combination thereof.

The interfaces 20, 21, in turn, may be coupled through a packet network 30, such as, for example, the Internet, a broadband network, a dedicated network, an asynchronous transfer mode network, a frame relay network, or any other suitable packet switching network. The interfaces 20, 21, provide the physical implementation of hardware, software, and/or firmware that allows the transmission and receipt of voice over the packet network 30. Additionally, each of the telephones T₁ to Tₙ and T-R₁ to T-Rₙ, may be digital, analog, or any other suitable telephone, while each of the personal computers PC₁ to PCₙ and PC-R₁ to PC-Rₙ, may be a personal computer (PC) or any other computing device capable of executing a software program.

During operation, for example during a call between two telecommunication devices such as the telephone T₁ and the personal computer PC-R₁, the transmitting device constructs digital data packets representative of voice communication. In this example, a user may initiate a voice transmission, by speaking into a receiver such as typically included in the telephone T₁. The telephone T₁ translates the user's voice into digital data and assembles packets, including header information for transmission as is understood by one of ordinary skill in the art. The data packet may be encoded, encrypted and/or compressed as desired. The telephone T₁ then transmits the assembled data packet at a predetermined frame rate to the destination device. The system 10 uses the header information associated with the assembled packet as routing information to direct the packet to the destination device, i.e., the personal computer PC-R₁, through the system 10. In one example, the telephone 12 transmits the data packets at a frame rate of one packet every 10 ms.

Whenever data is to be transmitted in a network operating in accordance with a packet protocol, a source device seeking to transmit the data must format the data into a datagram including one or more independent packets. Each packet is treated independently by the routers/switches in the packet network 30, such that the packets in a datagram transmitted from a source device to a receiving device may be separated and routed through different channels and reassembled at the device. Therefore, each packet must contain the addressing information necessary to route the packet to the intended destination device. To this end, each packet is provided with header followed by a data field. The header contains many well known fields including, for example, a version field, an header length field, a type of service field, a total length field, an identification field, a flags field, a fragment offset field, a protocol field, a header checksum field, a source address field, a destination address field, an options field, and a padding field. These fields are well known to persons of ordinary skill in the art and will not be discussed in detail herein.

The transmission rate of the assembled packets is dependent upon the internal clock rate of the transmitting device. Specifically, packets from the transmitting device are forwarded at a pre-determined interval utilizing the device's internal clock. This nominal packet transmission rate can vary slightly between transmitting devices depending upon the true speed of their clocks. The packets traverse the packet network 30 and arrive at the receiving device (e.g., personal computer PC-R₁) where the packets are decoded, decrypted, and/or decompressed and translated from digital data into reproducible voice communication. In this example, the personal computer PC-R₁ may translate the data into sound reproducible on a speaker allowing a user to listen to the voice transmission.

Due to the nature of packet networks, wherein a dedicated circuit is not established between two transmitting and receiving devices and many different transmissions are shared, delay may be introduced into the transmission. This is commonly known as “jitter.” Jitter is a variation in packet transit delay caused by queuing, contention and serialization effects on the path through the network. In general, higher levels of jitter are more likely to occur on either slow or heavily congested links. Some control mechanisms such as class based queuing, bandwidth reservation and/or higher speed links such as 100 Megabits (Mb) Ethernet, E3/T3 and SDH may reduce the incidence of jitter related problems.

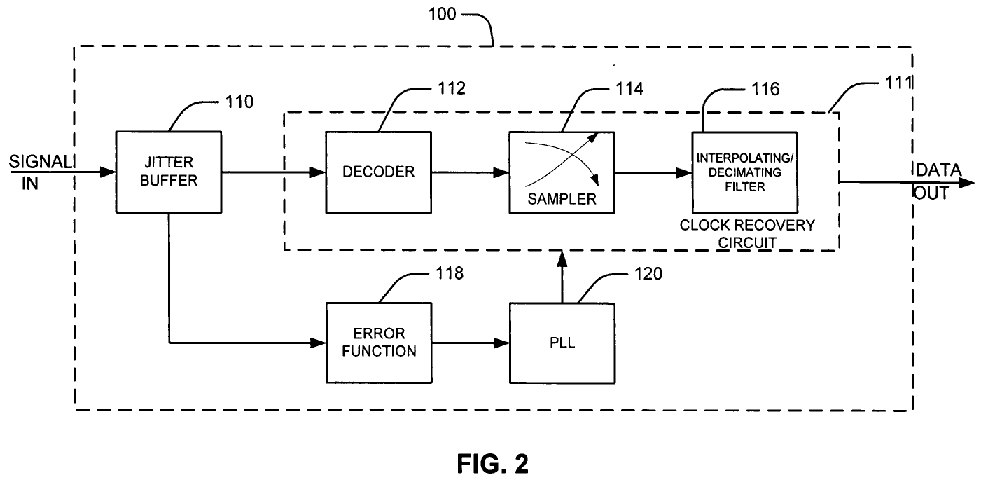

Turning now to FIG. 2, there is illustrated an example receiving device 100 for receiving incoming voice packets from a transmitting device, which may be, for example, at the personal computer PC-R₁ illustrated in FIG. 1. The receiving device 100 includes a jitter buffer 110, and a clock recovery circuit 111 including a decoder 112, a sampler 114, and an interpolating/decimating filter 116. The receiving device 100 also includes an error function 1118, and a phase-locked loop (PLL) 120. It will be appreciated by one of ordinary skill in the art that while the device 100 is illustrated with a plurality of distinct components, the implementation of the receiving device 100 may include additional components and/or may combine or divide the illustrated components as desired.

In operation, packets transmitted by a transmitting device (e.g. telephone T₁), and intended for the device 100 are received from the packet network 30 by the jitter buffer 110. The jitter buffer 110 is a shared data area in which voice packets can be collected, stored, and sent to the voice processor 111 in evenly spaced intervals. The size of the jitter buffer 110 may be static or dynamic depending upon the design requirements. For instance, a static jitter buffer may be configured by the manufacturer, while a dynamic jitter buffer may be configured to adapt to changes in network delay.

The clock recovery circuit 111 retrieves the packets buffered in the jitter buffer 110 according the same pre-determined frame rate as transmitted. For example, in the above-described transmission scenario, the clock recovery circuit 111 will retrieve a frame from the jitter buffer 110 every 10 ms, which is the rate at which the packets were transmitted by the transmitting device. The clock recovery circuit 111 retrieves the frames from the jitter buffer 110 based upon the PLL 120, as described below. Too many packets accumulating in the jitter buffer 110 indicates that the local clock is slower than the transmitting clock, and that the packets are being decoded at a rate slower than the packet arrival rate. If no packet is available in the jitter buffer 110, it indicates that the local clock is faster than the packet arrival rate, and that the packets are being decoded at a rate that is faster than the packet arrival rate.

Upon retrieving the packet from the jitter buffer 110, the clock recovery circuit 111 receives the packet in the decoder 112. The decoder 112 receives unidirectional traffic from the jitter buffer 110, and its function typically includes de-packetization of the received packet, extraction of the payload (i.e., the compressed data) and de-compression of the extracted payload to the originally transmitted audio data. The rate at which the decoder 112 retrieves data from the jitter buffer 110 is controlled by the sampler 114. Specifically, the sampler 114 synchronizes the capture and processing of the data in the decoder 112 in coordination with the clock rate signal received from the PLL 120.

As disclosed herein, the PLL 120 adapts the local clock rate (i.e., the clock rate associated with the internal processor in the device 100) to synchronize the PLL 120 with the clock rate of the transmitting device. In theory, the PLL 120 should be synchronized with the clock rate of the transmitting device, but in reality, even seemingly insignificant changes in the structure of the internal processor, such as for example differences in the silica, the clock rates may or may not be exactly synchronized.

As disclosed herein, the error function 118 determines if there was an error in the synchronization of the packet retrieval by the voice processor 111. For example, if too many packets are accumulating in the jitter butter 110, the error function 118 indicates that the local clock, and specifically, the output of the PLL 120, is slower than the transmitting clock, and thus the signal generated by the PLL 120 is causing the sampler 114 to instruct the decoder 112 to process the packets at a rate that is slower than the packet arrival rate. If insufficient data to form a packet is available in the jitter buffer 110, the error function 118 indicates that the local clock is faster than the transmitting clock, and thus the signal generated by the PLL 120 is causing the sampler 114 to instruct the decoder 112 to process the packets at a rate that is faster than the packet arrival rate. To determine if there is a synchronization error, the error function 118 may perform a calculation indicative of the relative difference between the packet arrival rate and the packet processing rate.

If the error function 118 determines that there is no error in the synchronization of the packet retrieval, the error function 118 will not instruct the PLL 120 to adjust its generated clock signal, and, therefore, the operation of the sampler 114 will not be affected. However, if the error function 118 determines that there is an error in the synchronization of the packet retrieval, the error function 118 calculates the error magnitude indicative of the relative difference between the packet arrival rate and the packet processing rate, and instructs the PLL 120 to adjust the generated clock signal in coordination with the error magnitude.

The interpolating/decimating filter 116 is adapted to alter the sampling rate of the waveform in the clock recovery unit 111 such that a data out signal remains constant. In particular, the sampler 114 is synchronized to the remote transmitters frame rate as described herein. Thus, the clock recovery unit signal up to the input to the interpolating/decimating filter 116 is synchronized to the remote transmission rate. However, the data out rate should remain constant since, as is well known, the data out signal rate is driven at a certain rate determined by external inputs. For example, the data out rate may be driven by the rate associated with connected telephony hardware. Thus, the interpolating/decimating filter 116 compensates for the difference between the two rates by altering the sampling rate of the waveform.

Once processing by the clock recover circuit 111 is complete, the data out signal is generated. The data out signal includes the extracted payload, which may be the originally transmitted audio data. In the disclosed example, the data out signal may be sent to a Pulse Code Modulation (PCM) buffer (not shown) for further processing. The payload may then be processed according to known processes to allow a user of the receiving device to hear the transmitted voice data. In this example, the audio data is a true representation of the received packet information, as no frames are added or duplicated, and no frames are dropped in response to under-sampling or over-sampling.

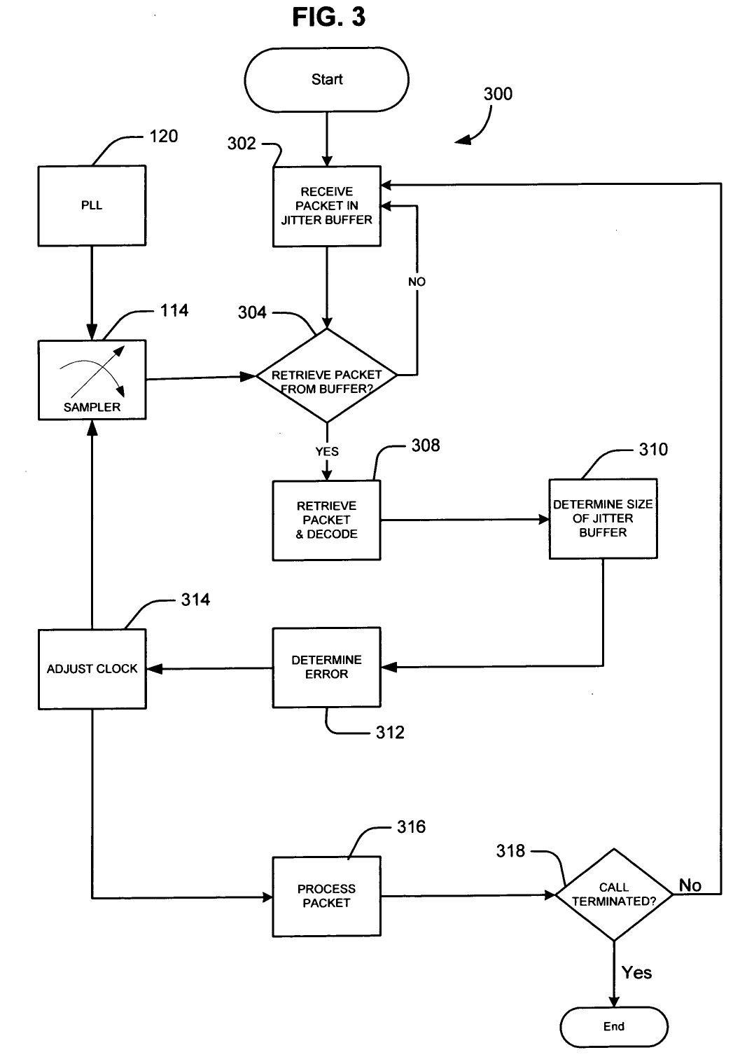

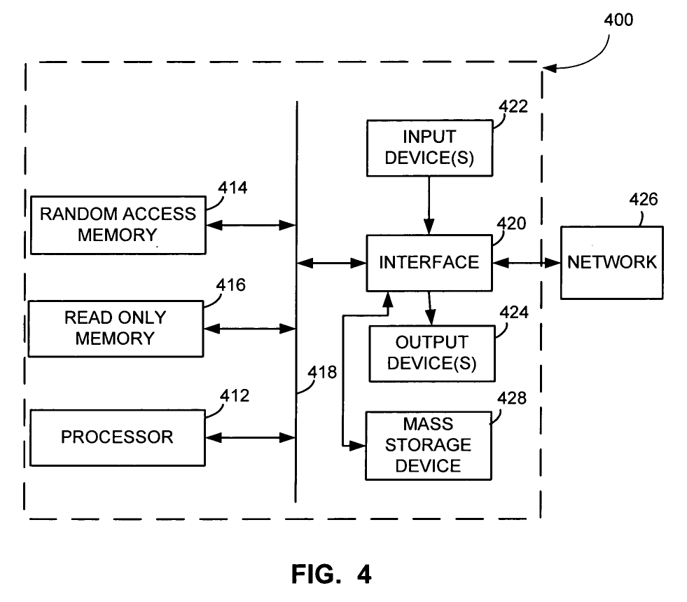

A flowchart representative of an example synchronization process 300 is shown in FIG. 3. The process 300 may be implemented using software, firmware, a combination thereof, or any other machine readable instructions executable by a processor, such as the processor 412 of FIG. 4. Additionally, some or all of the process may be implemented using hardware or any combination of hardware, software, or firmware. Alternatively, the process 300 may be implemented including one or more manual tasks. The process 300 may be embodied in software stored on a tangible medium such as a CD-ROM, a floppy disk, a hard drive, a digital versatile disk (DVD), or a memory associated with the processor 412, but persons of ordinary skill in the art will readily appreciate that the entire program and/or parts thereof could alternatively be executed by a device other than the processor 412 and/or embodied in firmware or dedicated hardware in a well known manner. For example, any or all of the jitter buffer 110, the clock recovery circuit 111, the decoder 112, the sampler 114, the interpolator/decimating filter 116, the error function 118, and/or the PLL 120 could be implemented by software, hardware, and/or firmware. Further, although the example process 300 is described with reference to the flowchart illustrated in FIG. 3, persons of ordinary skill in the art will readily appreciate that many other methods of implementing the example apparatus 100 may alternatively be used. For example, the order of execution of the blocks may be changed, and/or some of the blocks described may be changed, eliminated, or combined.

The process 300 of FIG. 3 begins when the receiving device 100, such as the personal computer PC-R₁, receives a packet from the transmitting device, such as the telephone T₁ (block 302). The receiving device 100 places the received packet in the jitter buffer 110 for later processing. After the packet has been placed in the jitter buffer 110 (block 302), the process 300 determines whether a packet should be retrieved from the jitter buffer 110 for processing (block 304). This may be carried out using the sampler 114. If no packet should be retrieved, i.e., the sampling time has not occurred, the process continues to place packets in the jitter buffer 110 (block 302) and test to determine if a packet is to be retrieved from the buffer 110 (block 304). The sampler 114 utilizes the PLL 120 to generate a sampling rate, as the clock recovery unit 120 is adapted to generate a clock signal, as described above.

When it is determined that a packet should be retrieved from the jitter buffer 110, a packet is retrieved and decoded (block 308) in accordance with well known retrieval techniques. The decoder 112 then processes the retrieved data by de-packetizating the retrieved packet, extracting the payload (i.e., the compressed data) and then de-compressing the packet to the originally transmitted audio data.

The system then calculates the size of the jitter buffer (block 310), and then an error is calculated based upon the depth (i.e., the size) of the jitter buffer 110 (block 312). For example, if too many packets are accumulating in the jitter butter 110, the local clock is slower than the transmitting clock, and packets are being decoded at a rate that is slower than the packet arrival rate. If no packet is available in the jitter buffer 110, the local clock is faster than the transmitting clock, and the packets are being decoded at a rate that is faster than the packet arrival rate.

Once the error is determined, the process 300 adjusts the clock rate and thus adjust the sampling rate of the sampler 114, utilizing calculated error (block 314). As noted earlier, the PLL 120 is configured to adapt the local clock rate to synchronize with the clock rate of the transmitting device.

If no error is detected in the retrieval packet (block 310), the packet is processed as described above (block 316). For instance, a data out signal is generated, including an extracted payload, which may be the originally transmitted audio data and may then be processed according to known processes to allow a user of the receiving device to hear the transmitted voice data.

The process 300 then determines whether the call has been terminated, i.e., whether additional packets are being received, or remain in the jitter buffer 110 (block 318). If it is determined that there are additional packets to retrieve, control passes back to the block 200 to retrieve additional packets. In this way, the processing of received packets results in a repetitive and iterative adjustment and synchronization of the clock in the receiving device. If it is determined that there are no additional packets to process, i.e, the call is terminated, the process is terminated.

FIG. 4 is a block diagram of an example computer 400 capable of implementing the apparatus and methods disclosed herein. The computer 400 can be, for example, a server, a personal computer, a telephone, an packet network interface, a personal digital assistant (PDA), an Internet appliance, a DVD player, a CD player, a digital video recorder, a personal video recorder, a set top box, or any other type of computing device.

The system 400 of the instant example includes a processor 412. For example, the processor 412 can be implemented by one or more Intel® microprocessors from the Pentium® family, the Itanium® family or the XScale® family. Of course, other processors from other families are also appropriate.

The processor 412 is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 416 may be implemented by flash memory and/or any other desired type of memory device. Access to the main memory 414, 416 is typically controlled by a memory controller (not shown) in a conventional manner.

The computer 400 also includes a conventional interface circuit 420. The interface circuit 420 may be implemented by any type of well known interface standard, such as an Ethernet interface, a universal serial bus (USB), and/or a third generation input/output (3GIO) interface.

One or more input devices 422 are connected to the interface circuit 420. The input device(s) 422 permit a user to enter data and commands into the processor 412. The input device(s) can be implemented by, for example, a keyboard, a mouse, a touchscreen, a track-pad, a trackball, isopoint and/or a voice recognition system.

One or more output devices 424 are also connected to the interface circuit 420. The output devices 424 can be implemented, for example, by display devices (e.g., a liquid crystal display, a cathode ray tube display (CRT), a printer and/or speakers). The interface circuit 420, thus, typically includes a graphics driver card.

The interface circuit 420 also includes a communication device (e.g., communication device 56) such as a modem or network interface card to facilitate exchange of data with external computers via a network 426 (e.g., an Ethernet connection, a digital subscriber line (DSL), a telephone line, coaxial cable, a cellular telephone system, etc.). The network 436 may, in this example, be the local network 28, or the packet network 30.

The computer 400 also includes one or more mass storage devices 428 for storing software and data. Examples of such mass storage devices 428 include floppy disk drives, hard drive disks, compact disk drives and digital versatile disk (DVD) drives. The mass storage device 428 may implement the local storage device 62.

From the foregoing, persons of ordinary skill in the art will appreciate that the above disclosed methods and apparatus employ a clock synchronization to improve the quality of service in a Voice over Packet Network. By synchronizing the clock of the receiving device to the same rate as the transmitting device, the disclosed methods and apparatus permit the received packet processing rate to be synchronized with the transmitted packet rate, thus eliminating the underflow or overflow of packets.

In the foregoing detailed description reference is made to the accompanying drawings that form a part hereof, and in which is shown by way of illustration specific embodiments in which the inventions may be practiced. These embodiments are described in sufficient detail to enable those of ordinary skill in the art to practice the methods and apparatus described. It is to be understood that other embodiments may be utilized and that various changes may be made without departing from the spirit and scope of the present disclosure. The foregoing detailed description is, therefore, not intended to limit the scope of the invention to the precise form or forms disclosed. Instead, the examples have been chosen and described in order to best explain the principles of the invention and its practical use so that others of ordinary skill in the art may follow its teachings. This patent covers all methods, apparatus and articles of manufacture fairly falling within the scope of the appended claims either literally or under the doctrine of equivalents.

What is claimed is:

1. A method of synchronizing a clock of a receiving device in a Voice over Packet network comprising:
receiving a data packet at a receiving device, the data packet being transmitted with an associated transmission frame rate determined by a remote clock signal;
storing the received data packet in a buffer;
generating a local clock signal
retrieving the data packet from the buffer at an associated retrieval frame rate determined by the local clock signal;
determining an error associated with the retrieval of the data packet from the buffer, the error indicative of the difference between the transmission frame rate and the retrieval frame rate; and
adjusting the retrieval frame rate in accordance with the determined error.

2. A method as defined in claim 1, wherein adjusting the retrieval frame rate includes performing at least one of interpolating or decimating the decoded signal.

3. A method as defined in claim 1, wherein retrieving the data packet from the buffer includes decrypting the received data packet.

4. A method as defined in claim 1, wherein receiving the data packet includes receiving the data packet from a packet network.

5. A method as defined in claim 4, wherein receiving the data packet includes receiving the data packet from at least one of the Internet, an Ethernet network, a local area network, a wide area network, a wireless network, a broadband network, a dedicated network, an asynchronous transfer mode network, a frame relay network, or a public switched telephone network.

6. A method of synchronizing a clock of a receiving device to a clock of a transmitting device in a Voice over Packet network comprising:
receiving a voice data packet at the receiving device, the data packet being transmitted with an associated transmission frame rate determined by the clock of the transmitting device;
storing the received voice data packet in a jitter buffer;
generating a local clock signal that is substantially synchronized with the clock of the receiving device;
retrieving the voice data packet from the jitter buffer at an associated retrieval frame rate determined by the local clock signal;
decoding the retrieved voice data packet;
determining an error associated with the retrieval of the data packet from the buffer, the error indicative of the difference between the transmission frame rate and the retrieval frame rate; and
performing at least one of increasing or decreasing the retrieval frame rate in accordance with the determined error.

7. A method as defined in claim 1, wherein retrieving the data packet from the buffer includes decrypting the received data packet.

8. A method as defined in claim 1, wherein receiving the data packet includes receiving the data packet from a packet network.

9. A method as defined in claim 8, wherein receiving the data packet includes receiving the data packet from at least one of the Internet, an Ethernet network, a local area network, a wide area network, a wireless network, a broadband network, a dedicated network, an asynchronous transfer mode network, a frame relay network, or a public switched telephone network.

10. A tangible medium storing machine readable instructions which, when executed by a machine, cause the machine to:
receive a data packet at a receiving device, the data packet being transmitted at a predetermined frame rate in a Voice over Packet Network;
store the received data packet in a buffer;
determine a sampling rate substantially synchronized with the predetermined frame rate;
retrieve the data packet from the buffer at the determined sampling rate;
determine an error rate indicative of the relative difference between the frame rate and the sampling rate; and
adjust the sampling rate in accordance with the determined error rate.

11. A tangible medium as defined in claim 10 wherein the data is received with encryption.

12. A tangible medium as defined in claim 11 wherein the machine readable instructions further cause the machine to decrypt the received data packet.

13. An apparatus to synchronize a local clock in a Voice of Packet network comprising:
a jitter buffer adapted to store data packets received from a packet network, the data packet being transmitted by a transmission device at a predetermined frame rate;
a clock recovery unit adapted to generate a local clock signal;
a voice processor adapted to retrieve and process data from data packet stored in the jitter buffer at a retrieval frame rate associated with the local clock signal; and
an error function adapted to calculate an error indicative of the difference between the transmission frame rate and the retrieval frame rate and adjust the retrieval frame rate in accordance with the error.

14. An apparatus as defined in claim 13, wherein the size of the jitter buffer is dynamically adjusted according to network delay.

15. An apparatus as defined in claim 13, wherein the voice processor includes a decoder adapted to de-packetize the received data packets and extract the data contained therein.

16. An apparatus as defined in claim 13, wherein the voice processor includes a sampler adapted to control the retrieval frame rate.

17. An apparatus as defined in claim 13, wherein the voice processor includes an interpolator/decimating filter to further adjust the retrieval frame rate.

18. A Voice over Packet system comprising:
a packet network; and
a plurality of communication devices electrically coupled to the packet network and adapted to transmit and receive voice communications, each of the communication devices adapted to:
receive a data packet transmitted at a predetermined frame rate;
store the received data packet in a buffer;
determine a sampling rate substantially synchronized with the predetermined frame rate;
retrieve the data packet from the buffer at the determined sampling rate;
determine an error rate indicative of the relative difference between the frame rate and the sampling rate; and
adjust the sampling rate in accordance with the determined error rate.

19. A Voice over Packet network as defined in claim 18, further comprising an interface device electrically coupling each of the communication devices to the packet network.

20. A Voice over Packet network as defined in claim 19, wherein each of the interface devices is electrically coupled to each of the communication devices by at least one of a telephony port, an Ethernet network, a local area network, a wide area network, or a wireless network.

21. A Voice over Packet network as defined in claim 19, wherein the interface device is at least one of a gateway, or a router.

22. A Voice over Packet network as defined in claim 18, wherein the packet network is at least one of the Internet, an Ethernet network, a local area network, a wide area network, a wireless network, a broadband network, a dedicated network, an asynchronous transfer mode network, a frame relay network, or a public switched telephone network.

23. A Voice over Packet network as defined in claim 18, wherein the communication devices is at least one of a telephone, a personal computer, a wireless communication device, or an analog telephone adaptor.

24. A Voice over Packet network as defined in claim 18, wherein each of the communication device is further adapted to adjust the size of the buffer according to delay associated with the packet network.

25. A Voice over Packet network as defined in claim 18, wherein each of the communication devices includes a decoder adapted to de-packetize the received data packets and extract the data contained therein.

26. A Voice over Packet network as defined in claim 18, wherein each of the communication devices includes a sampler adapted to control the sampling rate.

27. A Voice over Packet network as defined in claim 18, wherein each of the communication devices includes an interpolator/decimating filter to adjust the sampling rate.
